(19) United States
(12) Patent Application Publication
(10) Pub. No.: US 2020/0387276 A1
(43) Pub. Date: Dec. 10, 2020

(54) VIRTUALIZATION OF PHYSICAL ACTIVITY SURFACE

(71) Applicant: Tangible Play, Inc., Palo Alto, CA (US)

(72) Inventors: Jerome Scholler, San Francisco, CA (US); Mark Solomon, San Jose, CA (US)

(21) Appl. No.: 16/893,353

(22) Filed: Jun. 4, 2020

Related U.S. Application Data
(60) Provisional application No. 62/857,268, filed on Jun. 4, 2019.

(51) Int. Cl. G06F 3/0484; G06K 9/00; G06F 40/186; G06F 40/169

(52) U.S. Cl. CPC G06F 3/0484; G06F 40/169; G06F 40/186; G06K 9/00718

(57) ABSTRACT

Various implementations for virtualization of physical activity scene include a method that includes capturing a video stream that includes an interactive sheet including an interactive area, identifying the interactive sheet, determining a virtual page based on the identity of the interactive sheet, displaying a graphical user interface embodying a virtual template, detecting an interaction on the interaction area of the interactive sheet, generating a virtual annotation based on the interaction in the interaction area, and updating the graphical user interface to include the virtual annotation.

### BACKGROUND

The present disclosure relates to a computing device.

Computing devices are often used to assist in educational instructions. These computing devices can run specific learning programs that allow students or children to learn as they interact with the programs on the computing device. These computing devices can often provide feedback quickly as the student inputs different answers. However, these specific learning programs running on the computing devices are limited because they a static and the same program is executed. This limit tailored learning for different students. Additionally, the learning opportunity is limited because the students are only able to learn from the program and are not able to fully interactive using tangible objects.

Worksheets, workbooks, and other physical teaching tools have been used by teachers to guide students learning and solve solutions in worksheets on their own. The worksheets provide a tangible and tactile medium for students to learn as they fill out and complete the worksheets. However, worksheets are limited in that the feedback does not happen until the worksheet is reviewed at a later time and there is a separation between the completing of the worksheet and the feedback on whether everything was correct.

Current solutions that attempt to combine the physical learning experience of a worksheet with a program running on a computer are limited to very specific programs and custom-tailored worksheets that are often difficult to use together in sync. Additionally, these current solutions have not seen a wide adoption because they are not intuitive to use and often take longer to setup and run than simple doing a worksheet by hand without the computing device. These existing solutions are not able to intuitively combine the digital information experience and the physical information experience together.

### SUMMARY

According to one innovative aspect of the subject matter in this disclosure, a method for virtualization of a physical activity surface is described. In an example implementation, a method includes capturing, using a video capture device associated with a computing device, a video stream of a physical activity scene, the video stream including an interactive sheet, the interactive sheet including an interaction area; identifying, using a processor of the computing device, the interactive sheet; determining, using the processor of the computing device, a virtual template based on the identity of the interactive sheet; displaying, on a display of the computing device, a graphical user interface embodying the virtual template; detecting, using the processor of the computing device, an interaction on the interaction area of the interactive sheet; generating, using the processor of the computing device, a virtual annotation based on the detected interaction on the interaction area; and updating, on the display of the computing device, the graphical user interface to include the virtual annotation.

Implementations may include one or more of the following features. The method where the interaction further may include a marking formed by a user in the interaction area. The method may include: detecting, using the processor of the computing device, the marking formed by the user in the interaction area; and determining, using the processor of the computing device, whether the marking matches an expected marking for the interaction area. The method may include: responsive to the marking matching the expected marking for the interaction area, generating a correct answer annotation and presenting the correct answer annotation on the graphical user interface; and responsive to the marking not matching the expected marking for the interaction area, generating an incorrect answer annotation and presenting the incorrect answer annotation on the graphical user interface. The incorrect answer annotation includes a graphical representation of steps to provide the correct answer annotation. The interaction on the interaction area is a marking on the interaction area and where the virtual annotation is a virtual representation of the marking. Displaying the graphical user interface embodying the virtual template further may include: determining, using the processor of the computing device, a position of the interactive sheet in the physical activity scene; aligning, using the processor of the computing device, the virtual template to the interactive sheet using the position of the interactive sheet in the physical activity scene; and displaying, using the processor of the computing device, the aligned virtual template in the graphical user interface. Aligning the virtual template to the interactive sheet signals to the processor of the computing device where the interaction area is located on the interactive sheet based on a mapping of an expected interaction area in the virtual template. Displaying a graphical user interface embodying the virtual template further may include: detecting, using the processor of the computing device, a color in the interaction area of the interactive sheet; determining a color adjustment for the virtual template by using the detected color in the interaction area as a color of a corresponding area of the virtual template; and displaying the virtual template in the graphical user interface with the detected color in the corresponding area of the virtual template.

One general aspect includes, the physical activity surface visualization system also includes a video capture device coupled for communication with a computing device, the video capture device being adapted to capture a video stream of a physical activity scene, the video stream including an interactive sheet, the interactive sheet including an interaction area; a detector coupled to the computing device, the detector being adapted to identify the interactive sheet and an interaction on the interaction area of the interactive sheet; a processor of the computing device, the processor being adapted to determine a virtual template based on the identity of the interactive sheet and generate a virtual annotation based on the detected interaction in the interaction area; and a display coupled to the computing device, the display being adapted to display a graphical user interface embodying the virtual template and update the graphical user interface to include the virtual annotation.

Implementations may include one or more of the following features. The physical activity surface visualization system where the interaction further may include a marking formed by a user in the interaction area. The detector is further configured to detect the marking formed by the user in the interaction area where the processor is further configured to determine whether the marking matches an expected marking for the interaction area. The physical activity surface visualization system may include: responsive to the marking matching the expected marking for the interaction area, the processor is further configured to generate a correct answer annotation and presenting the correct answer annotation on the graphical user interface; and responsive to the marking not matching the expected marking for the interaction area, the processor is further configured to generate an incorrect answer annotation and presenting the incorrect answer annotation on the graphical user interface. The incorrect answer annotation includes a graphical representation of steps to provide the correct answer annotation. The interaction on the interaction area is a marking on the interaction area and where the virtual annotation is a virtual representation of the marking. Colon> the processor is further configured to determine a position of the interactive sheet in the physical activity scene and align the virtual template to the interactive sheet using the position of the interactive sheet in the physical activity scene; and the display is further configured to present the aligned virtual template in the graphical user interface. When the processor aligns the virtual template to the interactive sheet the processor identifies where the interaction area is located on the interactive sheet based on a mapping of an expected interaction area in the virtual template. Colon> the processor is further configured to detect a color in the interaction area of the interactive sheet and determine a color adjustment for the virtual template by using the detected color in the interaction area as a color of a corresponding area of the virtual template; and the display is further configured to display the virtual template in the graphical user interface with the detected color in the corresponding area of the virtual template.

One general aspect includes, the method also includes capturing, using a video capture device associated with a computing device, a video stream of a physical activity scene, the video stream including an interactive sheet that includes one or more interaction areas and a visual marking; detecting, using a processor of the computing device, the visual marking from the video stream; identifying, using the processor of the computing device, the detected visual marking; retrieving, using the processor of the computing device, a virtual template based on the identified visual marking; aligning, using the processor of the computing device, the virtual template with a position of the interactive sheet; determining, using the processor of the computing device, an expected location of the one or more interaction areas from the virtual template based on the aligning of the virtual template; detecting, using the processor of the computing device, an interaction in the one or more interaction areas on the interactive sheet using the expected location of the one or more interaction areas; identifying, using the processor of the computing device, the interaction in the one or more interaction areas; generating, using the processor of the computing device, a virtual annotation based on the identity of the interaction; and displaying, on a display of the computing device, a graphical user interface that includes the virtual template and the virtual annotation. Implementations may include one or more of the following features. The method where the interaction is a marking formed by a user in the one or more interaction areas.

Other implementations of one or more of these aspects and other aspects described in this document include corresponding systems, apparatus, and computer programs, configured to perform the actions of the methods, encoded on computer storage devices. The above and other implementations are advantageous in a number of respects as articulated through this document. Moreover, it should be understood that the language used in the present disclosure has been principally selected for readability and instructional purposes, and not to limit the scope of the subject matter disclosed herein.

### BRIEF DESCRIPTION OF THE DRAWINGS

The disclosure is illustrated by way of example, and not by way of limitation in the figures of the accompanying drawings in which like reference numerals are used to refer to similar elements.

FIGS. 1A-1D are example configurations of visualization of a physical activity surface.

FIG. 2 is a block diagram illustrating an example computer system for visualization of a physical activity surface.

FIG. 3 is a block diagram illustrating an example computing device.

FIG. 4 is a flowchart of an example method for visualization of a physical activity surface.

FIGS. 5A-5E are another example configuration of visualization of a physical activity surface.

### DETAILED DESCRIPTION

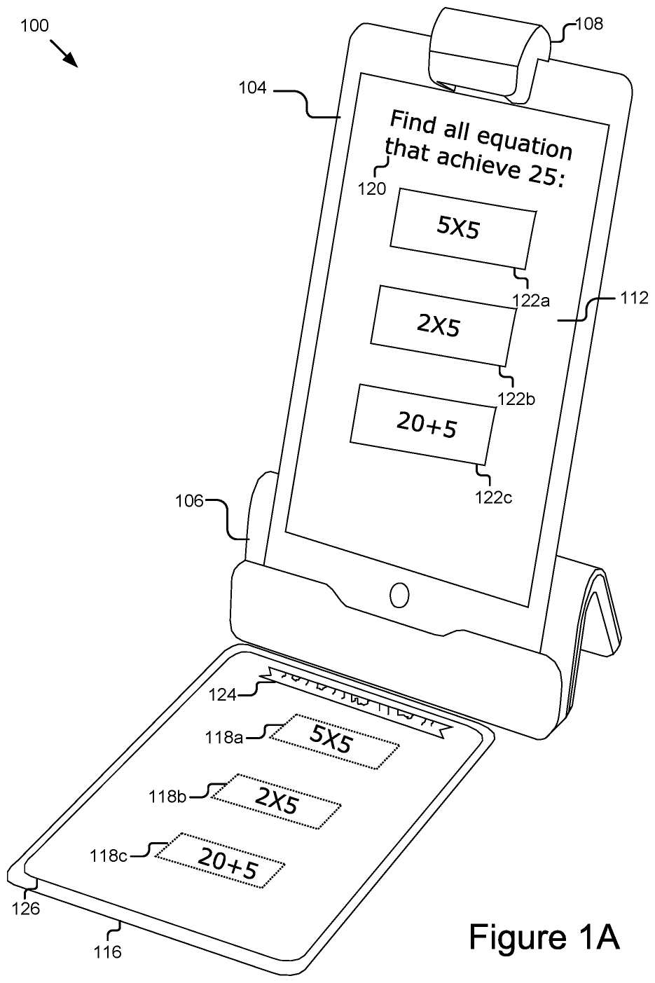

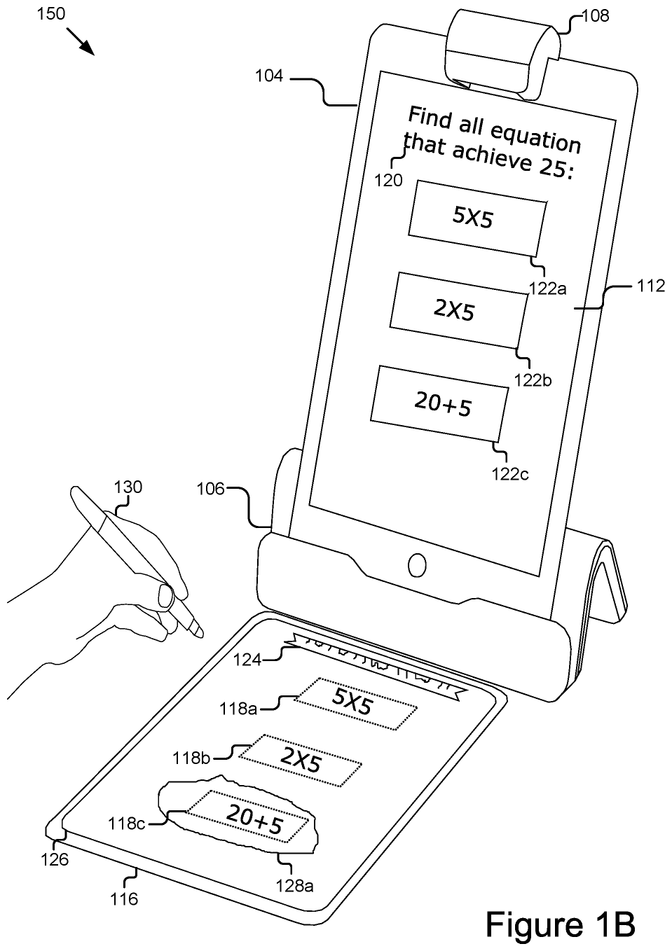

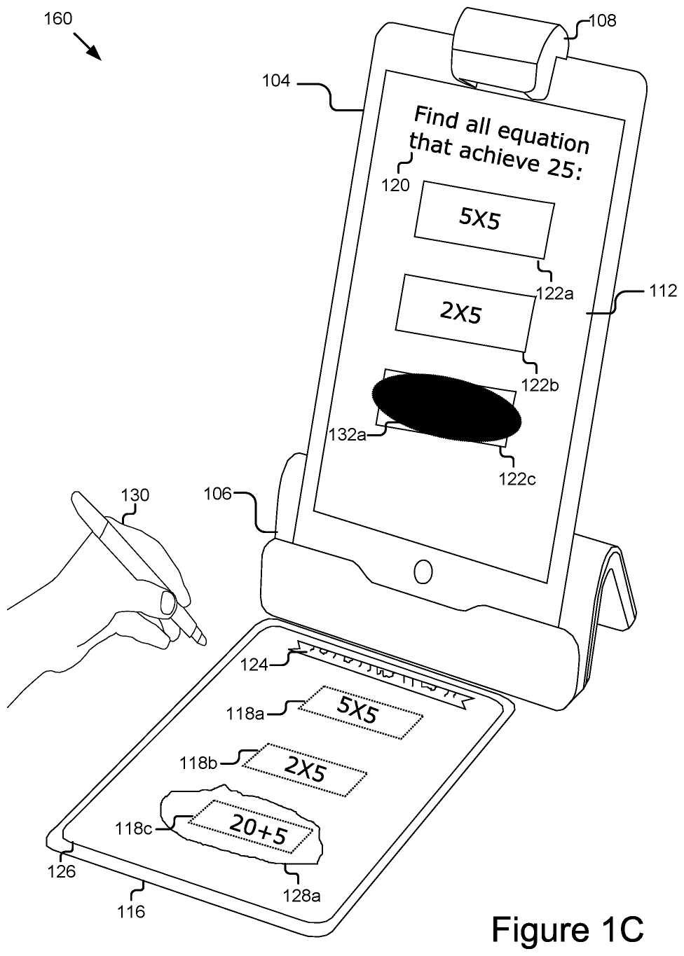

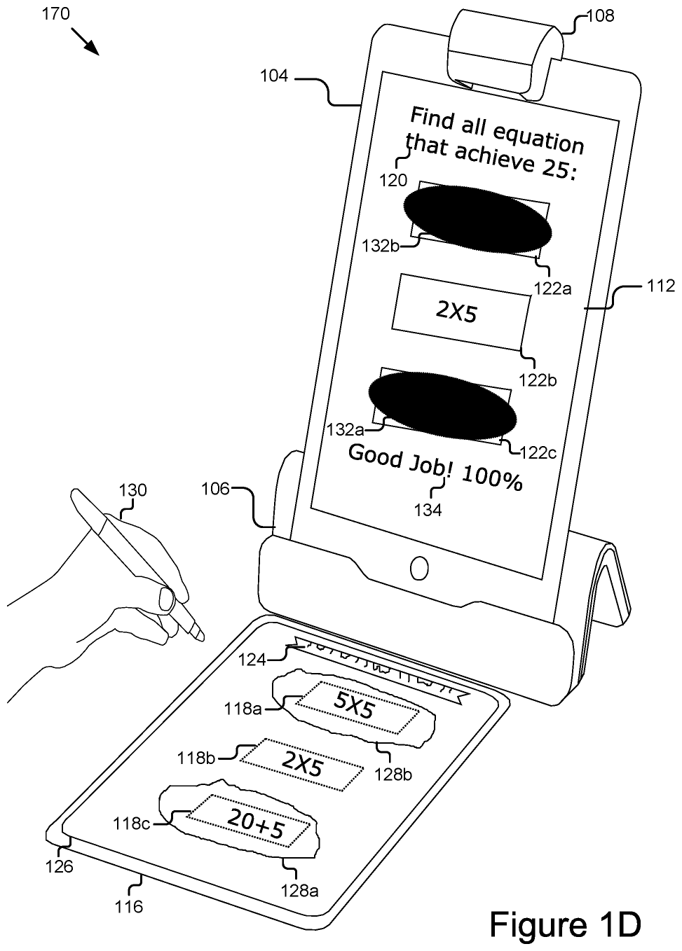

FIGS. 1A-1D are example configurations of virtualization of an interactive sheet 116 on a physical activity surface. FIG. 1A is an example configuration 100 that may be used for various activities in the physical activity scene that includes an interactive sheet 116. As depicted, the configuration 100 includes, in part, a tangible, physical activity surface (not shown) on which the interactive sheet 116 may be positioned (e.g., rested, placed, drawn, created, molded, built, projected, etc.) and a computing device 104 that is equipped or otherwise coupled to a video capture device 110 (not shown) configured to capture video of the activity surface that includes the physical activity scene of the interactive sheet 116. In some implementations, a camera adapter 108 may be used to redirect a field of view of the video capture device 110 as described elsewhere herein. In further implementations, the field of view of the video capture device 110 may be directed towards the interactive sheet 116 without the use of the camera adapter 108. The computing device 104 includes novel software and/or hardware capable of displaying a virtual template 112 that is based on the interactive sheet 116. The virtual template 112 may include annotations, such as a virtual prompt 120 and/or virtual elements 122.

While the activity surface on which the platform is situated is depicted as substantially horizontal in FIG. 1, it should be understood that the activity surface can be vertical or positioned at any other angle suitable to the user for interaction. The activity surface can have any color, pattern, texture, and topography. For instance, the activity surface can be substantially flat or be disjointed/discontinuous in nature. Non-limiting examples of an activity surface include a table, desk, counter, ground, a wall, a whiteboard, a chalkboard, a customized surface, a user's lap, etc.

In some implementations, the activity surface may be preconfigured for use with an interactive sheet 116. While in further implementations, the activity surface may be any surface on which the interactive sheet 116 may be positioned. It should be understood that while the interactive sheet 116 is presented as a flat object, such as a piece of paper, a page from a workbook, or a whiteboard, etc., the interactive sheet 116 may be any object on which an interaction may occur in an interaction area, such as notepad page made out of paper or cardstock, or an activity board made out of sturdy plastic, metal, and/or cardboard, in further implementations the interactive sheet 116 may be a book or workbook, a whiteboard/chalkboard, another display screen, such as a touchscreen tablet, etc. In further implementations, the interactive sheet 116 may be configured for creating and/or drawing, such as a notepad, whiteboard, or drawing board. In some implementations, the interactive sheet 116 may be reusable and one or more interaction areas 118 may be present as portions or areas of the interactive sheet 116. These interaction areas 118 may be areas where an activity application 214 operating on the computing device 104 may expect markings or other physical objects to be present. In some implementations, these interaction areas 118 may be formed or printed onto the interactive sheet 116, while in further implementations, the interaction areas 118 may be manipulated by a user, such as to cause one or more of the interaction areas 118 to be removed, erased, hidden, etc.

In some implementations, the interactive sheet 116 may include an interaction area 118 that includes a portion of the interactive sheet 116. In some implementations, the interaction area 118 may signal to a user where an interaction is expected to occur, such as writing an answer, circling an object, drawing a picture, etc. In some implementations, the interaction area 118 may be visible to the user, such as by creating a box or other shape and emphasizing the edges of the interaction area 118, such as by creating contrasting colors, a dotted line, etc. In some implementations, the interaction area 118 may be detectable by the computing device 104 and the computing device 104 may be configured to analyze the interaction area using image processing techniques to detect an interaction in the interaction area 118. In some implementations, the edges of the interaction area 118 may not be visible to a user 130 and the interactive sheet 116 or the virtual template 112 may signal where the user 130 should perform an interaction. For example, the interactive sheet 116 may be a math worksheet and the interaction area 118 may include different mathematical equations that are associated with a virtual prompt 120 in the virtual template 112. In some implementations, the interaction areas 118 may be identified in a static image or video steam of the interactive sheet 116 capture by the video capture device 110 and an activity application 214 may expect where the interaction areas 118 are on the interactive sheet 116 based on the virtual template 112 that has been associated with the interactive sheet 116 as described elsewhere herein.

In some implementations, the interactive sheet 116 may include a visual marker 124. The visual marker 124 may include graphical elements that are detectable by the computing device 104 and represent various identification features of the interactive sheet 116. For example, the interactive sheet 116 may be a specific math worksheet that is associated with a specific virtual template 112 and each interactive sheet 116 may have a different visual marker 124 that is unique to that interactive sheet 116 and matches with an associated virtual template 112. The computing device 104 may be able to detect the visual marker 124 and determine an identity of the interactive sheet 116 using the visual marker 124. The computing device 104 may then retrieve a virtual template 112 that is associated with the identity of the interactive sheet 116 and automatically present the virtual template 112 on the display screen of the computing device 104, without any input from the user 130.

In some implementations, the interactive sheet 116 may be integrated with a stand 106 that supports the computing device 104 or may be distinct from the stand 106 but placeable adjacent to the stand 106. In some instances, the size of the interactive area on the physical activity scene that includes the interactive sheet 116 may be bounded by the field of view of the video capture device 110 (not shown) and can be adapted by an adapter 108 and/or by adjusting the position of the video capture device 110. In additional examples, the interactive sheet 116 may be a light projection (e.g., pattern, context, shapes, etc.) projected onto the activity surface 102 or a second computing device (not shown) on which digital content may be displayed and captured by the video capture device 110 of the first computing device 104.

In some implementations, the computing device 104 included in the example configuration 100 may be situated on the surface or otherwise proximate to the surface. The computing device 104 can provide the user(s) 130 with a virtual portal for displaying the virtual template 112. For example, the computing device 104 may be placed on a table in front of a user 130 so the user 130 can easily see the computing device 104 while interacting with and/or forming the interaction area 118 on the interactive sheet 116. Example computing devices 104 may include, but are not limited to, mobile phones (e.g., feature phones, smart phones, etc.), tablets, laptops, desktops, netbooks, TVs, set-top boxes, media streaming devices, portable media players, navigation devices, personal digital assistants, etc.

The computing device 104 includes or is otherwise coupled (e.g., via a wireless or wired connection) to a video capture device 110 (also referred to herein as a camera) for capturing a video stream of the physical activity scene. As depicted in FIGS. 1A-1D the video capture device 110 may be a front-facing camera that is equipped with an adapter 108 that adapts the field of view of the camera 110 to include, at least in part, the interactive sheet 116. For clarity, the physical activity scene of the activity surface captured by the video capture device 110 is also interchangeably referred to herein as the activity surface or the activity scene in some implementations.

As depicted in FIGS. 1A-1D, the computing device 104 and/or the video capture device 110 may be positioned and/or supported by a stand 106. For instance, the stand 106 may position the display of the computing device 104 in a position that is optimal for viewing and interaction by the user who may be simultaneously forming the tangible interface object 120 and/or interacting with the physical environment (interactive sheet 116), such as in a substantially vertical position so that a user 130 can be positioned in front of the computing device 104 as the computing device 104 rests on the physical activity surface. The stand 106 may be configured to rest on the activity surface 102 and receive and sturdily hold the computing device 104 so the computing device 104 remains still during use.

In some implementations, the interactive sheet 116 may be used with a computing device 104 that is not positioned in a stand 106 and/or using an adapter 108. The user 130 may position and/or hold the computing device 104 such that a front facing camera or a rear facing camera may capture the interactive sheet 116 and then a virtual template 112 may be presented on the display of the computing device 104 based on the capture of the interactive sheet 116. In further implementations, the computing device 104 and the stand 106 may be integrated into a single housing (not shown) and may be a single device that may also include a camera adapter 108 in some implementations, while in further implementations, the video capture device 110 may be directed towards a physical activity surface without the camera adapter 108.

In some implementations, the adapter 108 adapts a video capture device 110 (e.g., front-facing, rear-facing camera) of the computing device 104 to capture substantially only the interactive sheet 116, although numerous further implementations are also possible and contemplated. For instance, the camera adapter 108 can split the field of view of the front-facing camera into two scenes. In this example with two scenes, the video capture device 110 captures a physical activity scene that includes a portion of the activity surface and is able to capture the interaction area 118 and/or the interactive sheet 116 in either portion of the physical activity scene. In another example, the camera adapter 108 can redirect a rear-facing camera of the computing device (not shown) toward a front-side of the computing device 104 to capture the physical activity scene of the activity surface 102 located in front of the computing device 104. In some implementations, the camera adapter 108 can define one or more sides of the scene being captured (e.g., top, left, right, with bottom open). In some implementations, the camera adapter 108 can split the field of view of the front facing camera to capture both the physical activity scene and the view of the user 130 interacting with the interactive sheet 116. In some implementations, if the user 130 consents to a recording of this split view for privacy concerns, a teacher can verify while remote that a student is not cheating or is following instructions by viewing the split video feeds that include both a first video stream of the interactive sheet 116 and the second video stream of the user 130. For example, a user can be filling out a math worksheet and the split view can show a split view, such as to a teacher or parent, that the user is answering the prompts themselves, rather than getting help from others. In further implementations, the split view may allow for real-time interactions, such as a tutor that is assisting remotely and can see both the user 130 in one portion of the view and the interactive sheet 116 in another. The tutor can see a look of confusion on the user's face and can see right where the user is stuck on the interactive sheet 116 in order to assist the user.

The adapter 108 and stand 106 for a computing device 104 may include a slot for retaining (e.g., receiving, securing, gripping, etc.) an edge of the computing device 104 to cover at least a portion of the camera 110. The adapter 108 may include at least one optical element (e.g., a mirror) to direct the field of view of the camera 110 toward the activity surface. The computing device 104 may be placed in and received by a compatibly sized slot formed in a top side of the stand 106. The slot may extend at least partially downward into a main body of the stand 106 at an angle so that when the computing device 104 is secured in the slot, it is angled back for convenient viewing and utilization by its user or users. The stand 106 may include a channel formed perpendicular to and intersecting with the slot. The channel may be configured to receive and secure the adapter 108 when not in use. For example, the adapter 108 may have a tapered shape that is compatible with and configured to be easily placeable in the channel of the stand 106. In some instances, the channel may magnetically secure the adapter 108 in place to prevent the adapter 108 from being easily jarred out of the channel. The stand 106 may be elongated along a horizontal axis to prevent the computing device 104 from tipping over when resting on a substantially horizontal activity surface (e.g., a table). The stand 106 may include channeling for a cable that plugs into the computing device 104. The cable may be configured to provide power to the computing device 104 and/or may serve as a communication link to other computing devices, such as a laptop or other personal computer.

In some implementations, the adapter 108 may include one or more optical elements, such as mirrors and/or lenses, to adapt the standard field of view of the video capture device 110. For instance, the adapter 108 may include one or more mirrors and lenses to redirect and/or modify the light being reflected from activity surface into the video capture device 110. As an example, the adapter 108 may include a mirror angled to redirect the light reflected from the activity surface 102 in front of the computing device 104 into a front-facing camera of the computing device 104. As a further example, many wireless handheld devices include a front-facing camera with a fixed line of sight with respect to the display of the computing device 104. The adapter 108 can be detachably connected to the device over the camera 110 to augment the line of sight of the camera 110 so it can capture the activity surface (e.g., surface of a table, etc.). The mirrors and/or lenses in some implementations can be polished or laser quality glass. In other examples, the mirrors and/or lenses may include a first surface that is a reflective element. The first surface can be a coating/thin film capable of redirecting light without having to pass through the glass of a mirror and/or lens. In an alternative example, a first surface of the mirrors and/or lenses may be a coating/thin film and a second surface may be a reflective element. In this example, the lights passes through the coating twice, however since the coating is extremely thin relative to the glass, the distortive effect is reduced in comparison to a conventional mirror. This mirror reduces the distortive effect of a conventional mirror in a cost-effective way.

In another example, the adapter 108 may include a series of optical elements (e.g., mirrors) that wrap light reflected off of the activity surface located in front of the computing device 104 into a rear-facing camera of the computing device 104 so it can be captured. The adapter 108 could also adapt a portion of the field of view of the video capture device 110 (e.g., the front-facing camera) and leave a remaining portion of the field of view unaltered so that multiple scenes may be captured by the video capture device 110. The adapter 108 could also include optical element(s) that are configured to provide different effects, such as enabling the video capture device 110 to capture a greater portion of the activity surface 102. For example, the adapter 108 may include a convex mirror that provides a fisheye effect to capture a larger portion of the activity surface than would otherwise be capturable by a standard configuration of the video capture device 110.

The video capture device 110 could, in some implementations, be a separate unit that is distinct from the computing device 104 and may be positionable to capture the activity surface 102 or may be adapted by the adapter 108 to capture the activity surface 102 as discussed above. In these implementations, the video capture device 110 may be communicatively coupled via a wired or wireless connection to the computing device 104 to provide it with the video stream being captured.

As shown in the example configuration 100 in FIG. 1A, the interactive sheet 116 may be positioned within a field of view of the video capture device 110. The interactive sheet 116 may include a visual marker 124 and one or more interaction areas 118. In the example, the interactive sheet 116 is a page of a worksheet or book, although other configurations are also contemplated for the interactive sheet 116. As shown in the example, visual marker 124 may be located at a top portion of the interactive sheet 116 and the visual marker 124 may include a unique graphical element detectable by the computing device 104, such as a page number, product number, QR code, unique graphical code, etc. and/or a graphic detectable by the computing device 104. In some implementations, the detection engine 212 may be programmed to look in a specific area of a detected interactive sheet 116 where a visual marker 124 is expected, such as a top of the sheet, a side of the sheet, etc. This is advantageous as it allows the detection engine 212 to quickly detect visual markers 124 without having to compare every portion of a detected object, such as an interactive sheet 116 with a database of identities and reduces processing time. In the example, the graphic represents graphical code within a banner signaling the type of interactive sheet 116. In some implementations, the interactive sheet 116 may also include a graphical element 126 that signals a boundary of the interactive sheet, such as a border around the outside of the interactive sheet 116.

In the example depicted in FIG. 1, the interactive sheet 116 includes three different interaction areas 118 representing different three different potential answers to a virtual prompt 120. The computing device 104 is expecting a user to interact with the interactive sheet 116 in and/or around the interactive areas 118. By anticipating the areas where the user will perform the interactions, the computing device 104 can target the interaction area 118 for image processing, rather than processing the entire video stream, which improves the speed of the image processing.

In the example in FIG. 1A, a user may place the interactive sheet 116 on the physical activity surface in front of the computing device 104. The computing device 104 may identify the interactive sheet 116 as a specific math worksheet where the user will interact with three different interaction areas 118a-118c where different math equations are presented. The computing device 104 may use the identity of the interactive sheet 116 to retrieve a virtual template 112 that is associated with the interactive sheet 116 and may display the virtual template 112 on a display of the computing device 104. The virtual template 112, in this example, may include a virtual prompt 120 that instructs a user 130 on how to complete the worksheet The virtual prompt 130 may be a question that is presented to the user 130 for the user 130 to answer. The question may be appropriate for different age levels, such as a sentence for older users 130 or a shape for younger users 130 that may not be ready to read and/or comprehend full text prompts. In some implementations, the virtual prompt 120 may be a virtual character or avatar that interacts with the user 130 and may use an audio output to speak a questions instead of displaying the question on the display screen. In further implementations, the prompt may instead and/or also be presented on the interactive sheet 116 so that the user 130 can complete the worksheet separate from the computing device 104. The user may respond to the virtual prompt 120 by interacting with the interaction areas 118 of the interactive sheet 116. In this example, the virtual prompt 120 is for a user to “Find all equations that achieve 25” from the options presented on the interactive sheet 116. The interactive sheet 116 includes an interaction area 118a with the equation “5×5”, the interaction area 118b with the equation “2×5”, and the interaction area 118c with the equation “20+5”.

In the example configuration 150 depicted in FIG. 1B, the user 130 may respond to the virtual prompt 120 by interacting 128a with interaction area 118c representing the equation “20+5”. The interaction 128a may be a circle drawn around the interaction area 118c. Alternatively, in other implementations, the interaction 128 may be any type of marking that is formed by the user 130 and within the expected interaction area 118, such as a check-mark, circle, written answer, filling in of the area, drawing a line/circle to connect two different areas, a touch by a finger/writing utensil, a placement of an object in an area, a color, a shape, etc.

In the example configuration 160 in FIG. 1C, the computing device 104 may detect the interaction 128a of the user 130 on the interactive sheet 116 and present a virtual annotation 132a in the virtual template. In some implementations, the virtual annotation 132a may provide feedback to the user 130, such that the answer is correct or incorrect, a hint on a next step, an elimination of other options, a reward visualization, such as a character that advances in a virtual game, a graphical element that is added to the virtual template, such as a color added to a character being colored in the interactive sheet 116, etc. In this example, the virtual annotation 132a may cover the correct virtual element 122c associated with the interactive area 118c and signal to the user that they correctly responded to the virtual prompt 120.

In the example configuration 170 in FIG. 1D, the user 130 may then perform another interaction 128b to select interaction area 118a as the user 130 continues to respond to the virtual prompt 120. The computing device 104 may detect the interaction 128b selecting the answer “5×5”, such as by detecting markings in the expected interaction area 118a and generate a virtual annotation 132b that covers virtual element 122a in order to signal to the user 130 that the interaction 128b was correct. Once the user has completed the interactive sheet 116, in this example, a virtual reward 134 may appear that indicates to the user 130 that the worksheet is complete. In this example, the virtual reward 134 may include the statement “Good Job! 100%” indicating that the user 130 responded correctly. The virtual reward 134 may also be an auditory prompt, a game element that advances a game based on correct responses, etc. As shown in this example, a user 130 may fill out a worksheet on an interactive sheet 116 and as the user responds, the virtual template 112 may include guidance, prompts, hints, rewards, etc. to encourage the user 130 to continue the worksheet as well as assist if the user 130 is unable to respond.

In other implementations, a user 130, such as a teacher, may create custom interactive sheets 116, such as by creating a worksheet and uploading that worksheet for a server to store and/or add interactive areas. For example, a teacher may upload a pdf and define an interactive area 118 in the worksheet where they expect the students to interact when filling out the worksheets. The server may receive these worksheets and identify these interactive areas in software for the virtual template 112. The server may then provide a printable version of the worksheets or simply store the virtual page based on the worksheets. In some implementations, the server may add a visual marker 124, that can be included in a printed version of the interactive sheet 116, which allows for the custom interactive sheet 116 to be catalogued and stored with an associated virtual template 112. Then later, a student may place a copy of the worksheet created by the teacher in front of the computing device 104 and the computing device 104 may retrieve and display the virtual template 112 for the student to interact with as the student completes the worksheet. This allows for easy onboarding. A teacher merely has to provide an interactive sheet 116 to the student and the software retrieves the virtual template 112 and runs the content without additional setup.

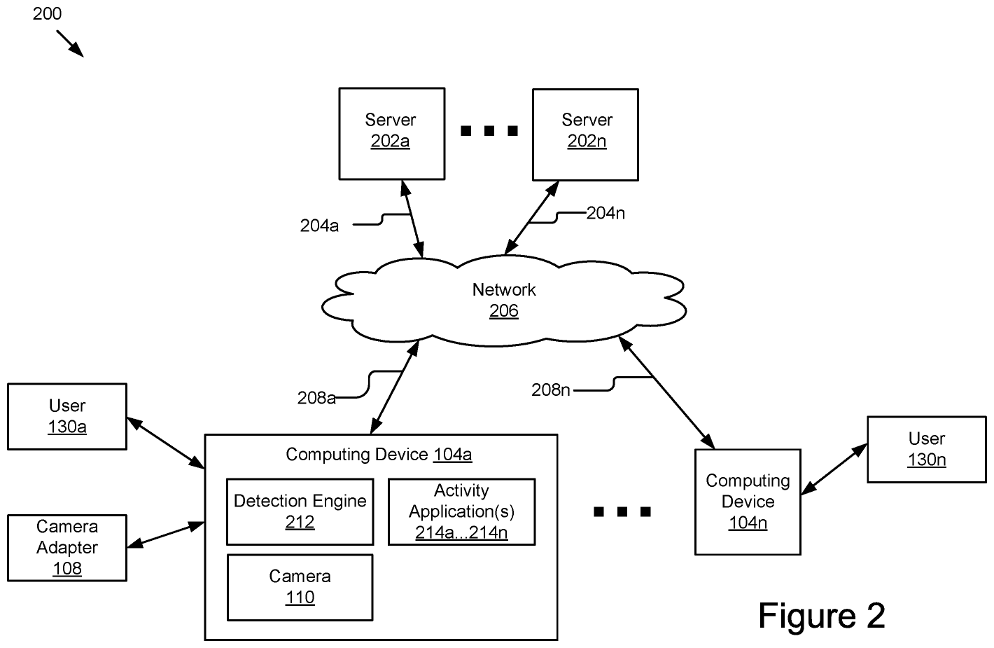

FIG. 2 is a block diagram illustrating an example computer system 200 for virtualization of a physical activity scene. The illustrated system 200 includes computing devices 104a . . . 104n (also referred to individually and collectively as 104) and servers 202a . . . 202n (also referred to individually and collectively as 202), which are communicatively coupled via a network 206 for interaction with one another. For example, the computing devices 104a . . . 104n may be respectively coupled to the network 206 via signal lines 208a . . . 208n and may be accessed by users 130a . . . 130n (also referred to individually and collectively as 130). The servers 202a . . . 202n may be coupled to the network 206 via signal lines 204a . . . 204n, respectively. The use of the nomenclature “a” and “n” in the reference numbers indicates that any number of those elements having that nomenclature may be included in the system 200.

The network 206 may include any number of networks and/or network types. For example, the network 206 may include, but is not limited to, one or more local area networks (LANs), wide area networks (WANs) (e.g., the Internet), virtual private networks (VPNs), mobile (cellular) networks, wireless wide area network (WWANs), WiMAX® networks, Bluetooth® communication networks, peer-to-peer networks, other interconnected data paths across which multiple devices may communicate, various combinations thereof, etc.

The computing devices 104a . . . 104n (also referred to individually and collectively as 104) are computing devices having data processing and communication capabilities. For instance, a computing device 104 may include a processor (e.g., virtual, physical, etc.), a memory, a power source, a network interface, and/or other software and/or hardware components, such as front and/or rear facing cameras, display, graphics processor, wireless transceivers, keyboard, camera, sensors, firmware, operating systems, drivers, various physical connection interfaces (e.g., USB, HDMI, etc.). The computing devices 104a . . . 104n may couple to and communicate with one another and the other entities of the system 200 via the network 206 using a wireless and/or wired connection. While two or more computing devices 104 are depicted in FIG. 2, the system 200 may include any number of computing devices 104. In addition, the computing devices 104a . . . 104n may be the same or different types of computing devices.

As depicted in FIG. 2, one or more of the computing devices 104a . . . 104n may include a camera 110, a detection engine 212, and activity application(s) 214. One or more of the computing devices 104 and/or cameras 110 may also be equipped with an adapter 108 as discussed elsewhere herein. The detection engine 212 is capable of detecting and/or recognizing the performance and/or location of an interaction on an interactive sheet 116 (e.g., on the activity surface within field of view of camera 110). The detection engine 212 can detect the position and orientation of the interactive sheet 116, detect how the interaction is being formed and/or manipulated by the user 130, and cooperate with the activity application(s) 214 to provide users 130 with a rich virtual experience by detecting an interaction and generating a virtual annotation 132 in the virtual template 112.

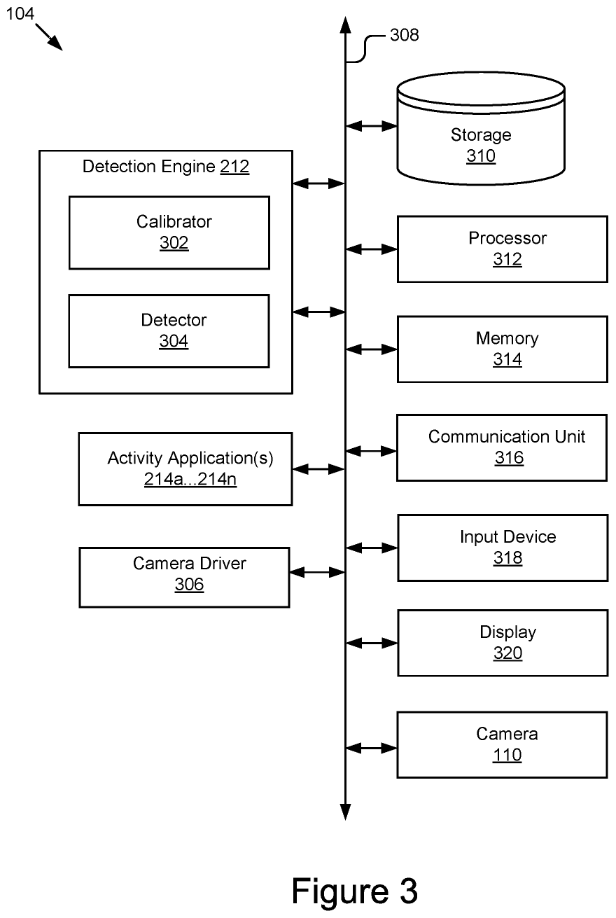

In some implementations, the detection engine 212 processes video captured by a camera 110 to detect the visual marker 124 and other elements to identify the interactive sheet 116. The activity application(s) 214 are capable of determining a virtual page and generating a virtualization. Additional structure and functionality of the computing devices 104 are described in further detail below with reference to at least FIG. 3.

The servers 202 may each include one or more computing devices having data processing, storing, and communication capabilities. For example, the servers 202 may include one or more hardware servers, server arrays, storage devices and/or systems, etc., and/or may be centralized or distributed/cloud-based. In some implementations, the servers 202 may include one or more virtual servers, which operate in a host server environment and access the physical hardware of the host server including, for example, a processor, memory, storage, network interfaces, etc., via an abstraction layer (e.g., a virtual machine manager).

The servers 202 may include software applications operable by one or more computer processors of the servers 202 to provide various computing functionalities, services, and/or resources, and to send data to and receive data from the computing devices 104. For example, the software applications may provide functionality for internet searching; social networking; web-based email; blogging; micro-blogging; photo management; video, music and multimedia hosting, distribution, and sharing; business services; news and media distribution; user account management; or any combination of the foregoing services. It should be understood that the servers 202 are not limited to providing the above-noted services and may include other network-accessible services.

It should be understood that the system 200 illustrated in FIG. 2 is provided by way of example, and that a variety of different system environments and configurations are contemplated and are within the scope of the present disclosure. For instance, various functionality may be moved from a server to a client, or vice versa and some implementations may include additional or fewer computing devices, services, and/or networks, and may implement various functionality client or server-side. Further, various entities of the system 200 may be integrated into a single computing device or system or additional computing devices or systems, etc.

FIG. 3 is a block diagram of an example computing device 104. As depicted, the computing device 104 may include a processor 312, memory 314, communication unit 316, display 320, camera 110, and an input device 318, which are communicatively coupled by a communications bus 308. However, it should be understood that the computing device 104 is not limited to such and may include other elements, including, for example, those discussed with reference to the computing devices 104 in FIGS. 1A-1D and 2.

The processor 312 may execute software instructions by performing various input/output, logical, and/or mathematical operations. The processor 312 has various computing architectures to process data signals including, for example, a complex instruction set computer (CISC) architecture, a reduced instruction set computer (RISC) architecture, and/or an architecture implementing a combination of instruction sets. The processor 312 may be physical and/or virtual, and may include a single core or plurality of processing units and/or cores.

The memory 314 is a non-transitory computer-readable medium that is configured to store and provide access to data to the other elements of the computing device 104. In some implementations, the memory 314 may store instructions and/or data that may be executed by the processor 312. For example, the memory 314 may store the detection engine 212, the activity application(s) 214, and the camera driver 306. The memory 314 is also capable of storing other instructions and data, including, for example, an operating system, hardware drivers, other software applications, data, etc. The memory 314 may be coupled to the bus 308 for communication with the processor 312 and the other elements of the computing device 104.

The communication unit 316 may include one or more interface devices (I/F) for wired and/or wireless connectivity with the network 206 and/or other devices. In some implementations, the communication unit 316 may include transceivers for sending and receiving wireless signals. For instance, the communication unit 316 may include radio transceivers for communication with the network 206 and for communication with nearby devices using close-proximity (e.g., Bluetooth®, NFC, etc.) connectivity. In some implementations, the communication unit 316 may include ports for wired connectivity with other devices. For example, the communication unit 316 may include a CAT-5 interface, Thunderbolt™ interface, FireWire™ interface, USB interface, etc.

The display 320 may display electronic images and data output by the computing device 104 for presentation to a user 130. The display 320 may include any conventional display device, monitor or screen, including, for example, an organic light-emitting diode (OLED) display, a liquid crystal display (LCD), etc. In some implementations, the display 320 may be a touch-screen display capable of receiving input from one or more fingers of a user 130. For example, the display 320 may be a capacitive touch-screen display capable of detecting and interpreting multiple points of contact with the display surface. In some implementations, the computing device 104 may include a graphics adapter (not shown) for rendering and outputting the images and data for presentation on display 320. The graphics adapter (not shown) may be a separate processing device including a separate processor and memory (not shown) or may be integrated with the processor 312 and memory 314.

The input device 318 may include any device for inputting information into the computing device 104. In some implementations, the input device 318 may include one or more peripheral devices. For example, the input device 318 may include a keyboard (e.g., a QWERTY keyboard), a pointing device (e.g., a mouse or touchpad), microphone, a camera, etc. In some implementations, the input device 318 may include a touch-screen display capable of receiving input from the one or more fingers of the user 130. For instance, the functionality of the input device 318 and the display 320 may be integrated, and a user 130 of the computing device 104 may interact with the computing device 104 by contacting a surface of the display 320 using one or more fingers. In this example, the user 130 could interact with an emulated (i.e., virtual or soft) keyboard displayed on the touch-screen display 320 by using fingers to contact the display 320 in the keyboard regions.

The detection engine 212 may include a detector 304. The elements 212 and 304 may be communicatively coupled by the bus 308 and/or the processor 312 to one another and/or the other elements 214, 306, 310, 314, 316, 318, 320, and/or 110 of the computing device 104. In some implementations, one or more of the elements 212 and 304 are sets of instructions executable by the processor 312 to provide their functionality. In some implementations, one or more of the elements 212 and 304 are stored in the memory 314 of the computing device 104 and are accessible and executable by the processor 312 to provide their functionality. In any of the foregoing implementations, these components 212, and 304 may be adapted for cooperation and communication with the processor 312 and other elements of the computing device 104.

The detector 304 includes software and/or logic for processing the video stream captured by the camera 110 to detect interactions, an interactive sheet 116, and/or a visual marker 124 included in the video stream. In some implementations, the detector 304 may identify line segments, contours, different colored pixels, and/or circles related to tangible interface object, markings or other annotations, and/or visual markers 124 included on the interactive sheet 116. In some implementations, the detector 304 may detect lighting environments and may match the various color adjustments that are detected on an interactive sheet 116 to a virtual template 112 of expected colors as described elsewhere herein. The lighting environment may include shadows, hands, modified colors, etc. In some implementations, the detector 304 may be coupled to and receive the video stream from the camera 110, the camera driver 306, and/or the memory 314. In some implementations, the detector 304 may process the images of the video stream to determine positional information for the line segments related to the tangible interface object and/or formation of a tangible interface object on the interactive sheet 116 associated with an interaction (e.g., location and/or orientation of the line segments in 2D or 3D space) and then analyze characteristics of the line segments included in the video stream to determine the identities and/or additional attributes of the line segments.

In some implementations, the detector 304 may use the visual markers 124 to recognize portions of the interactive sheet 116, such as corners of a page, etc. The detector 304 may perform a straight line detection algorithm and a rigid transformation to account for distortion and/or bends on the interactive sheet 116. In some implementations, the detector 304 may match features of detected line segments to a reference page that may include a depiction of the reference object in order to determine the line segments and/or the boundary of the expected objects in the interactive sheet 116. In some implementations, the detector 304 may account for gaps and/or holes in the detected line segments and/or contours and may be configured to generate a mask to fill in the gaps and/or holes.

In some implementations, the detector 304 may recognize the line by identifying its contours. The detector 304 may also identify various attributes of the line, such as colors, contrasting colors, depth, texture, etc. In some implementations, the detector 304 may use the description of the line and the lines attributes to identify an object, marking, or interaction by comparing the description and attributes to a database of objects and identifying the closest matches.

In some implementations, the detector 304 may perform color adjustments to the virtual template 112 based on the detected interactive sheet 116. For example, the detector 304 may identify different expected colors on the virtual template 112 and may identify the received colors in the video stream that correspond to areas of the interactive sheet 116. This allows the detector 304 to identify how those colors may be changed or affected by different external parameters, such as lighting effects on the interactive sheet 116. For example, the detector 304 can identify a portion of the interactive sheet 116 that is expected to be white based on the template and use that detected color as the color white for anything displayed on the virtual template 112. This process allows the detector 304 to estimate and match true colors from the interactive sheet 116 without having to make changes for luminosity adjustments or contrast adjustments. Instead, the detector 304 can identify each color from the expected areas of the interactive sheet 116 and use those identified colors when the virtual template 112 is displayed. In further implementations, the detector 304 and/or the calibrator 302 may also perform additional image processing to remove the lighting and deformation from a capture video stream of the interactive sheet 116.

The detector 304 may be coupled to the storage 310 via the bus 308 to store, retrieve, and otherwise manipulate data stored therein. For example, the detector 304 may query the storage 310 for data matching any line segments that it has determined are present in the interactive sheet 116. In all of the above descriptions, the detector 304 may send the detected images to the detection engine 212 and the detection engine 212 may perform the above described features.

The detector 304 may be able to process the video stream to detect an interaction between the interactive sheet 116 and an interaction area 118. In some implementations, the detector 304 may be configured to understand relational aspects between an object and determine an interaction based on the relational aspects. For example, the detector 304 may be configured to identify an interaction related to one or more tangible interface object present in the interactive sheet 116 and the activity application(s) 214 may determine a routine based on the relational aspects between the more tangible interface object and other elements of the interactive sheet 116.

The detector 304 may be able to process the video stream to detect an occlusion of an area of an interactive sheet 116, such as by a user's hand 130 or other object. The detector 304 may compare different frames of the video stream captured at different times within a defined period of time and determine if an object is occluding a portion of an interactive sheet 116. The detector 304 may determine if the object is occluding a portion of the interactive sheet 116 by identifying differences between the two frames and determining which frames do not include expected portions of the interactive sheet 116 based on the virtual template 112, such as when a hand is blocking that portion if one frame. The detector 304 may be further configured to create a mask layer based on the detected occlusion and ignore the parts of the interactive sheet 116 that are occluded while also displaying any detected changes that relate to markings in the interaction areas 118. The mask layer may allow the detector 304 to display updated annotations on the virtual template 112 in substantially real-time without waiting for an object that is occluding part of the field of view of the video capture device 110 to move out of the way.

The activity application(s) 214 include software and/or logic for identifying an interactive sheet 116, presenting a virtual template 112, detecting interactions with the interactive sheet 116, and generating virtual annotations 132 to display as the interactions are detected. The activity application(s) 214 may be coupled to the detector 304 via the processor 312 and/or the bus 308 to receive the information. For example, a user 130 may draw a word formed out of letters on a worksheet and the activity application(s) 214 may determine what words the letters form and if that word is correct based on the identity of the specific interactive sheet 116 and expected answers based on the virtual prompt 120.

In some implementations, the activity application(s) 214 may detect an interaction and/or a routine by searching through a database of virtual objects and/or routines that are compatible with the detected interaction in the interaction area 118. In some implementations, the activity application(s) 214 may access a database of virtual objects or virtual templates 112 stored in the storage 310 of the computing device 104. In further implementations, the activity application(s) 214 may access a server 202 to search for virtual objects and/or virtual templates 112, and/or routines. In some implementations, a user 130 may predefine a virtual template 112 to include in the database.

In some implementations, the activity application(s) 214 may enhance the virtual template 112 and/or a virtualization as part of a routine. For example, the activity application(s) 214 may display visual enhancements as part of executing the routine. The visual enhancements may include adding color, extra virtualizations, background scenery, etc. In further implementations, the visual enhancements may include having a virtualization or virtual annotation 132 move or interact with another virtualization (not shown) and/or the virtual element 122 in the virtual template 112. In some implementations, the activity application(s) 214 may prompt the user 130 to select one or more enhancement options, such as a change to color, size, shape, etc. and the activity application(s) 214 may incorporate the selected enhancement options into the virtual template 112.

In some instances, the interaction in the interaction area 118 by the user 130 in the physical activity scene may be incrementally presented in the virtual template 112 as the user 130 interacts. For example, as a user navigates a maze on the interactive sheet 116, the navigation of the maze may be presented in the virtual template in substantially real-time. Non-limiting examples of the activity applications 214 may include video games, learning applications, assistive applications, storyboard applications, collaborative applications, productivity applications, etc.

The camera driver 306 includes software storable in the memory 314 and operable by the processor 312 to control/operate the camera 110. For example, the camera driver 306 is a software driver executable by the processor 312 for signaling the camera 110 to capture and provide a video stream and/or still image, etc. The camera driver 306 is capable of controlling various features of the camera 110 (e.g., flash, aperture, exposure, focal length, etc.). The camera driver 306 may be communicatively coupled to the camera 110 and the other components of the computing device 104 via the bus 308, and these components may interface with the camera driver 306 via the bus 308 to capture video and/or still images using the camera 110.

As discussed elsewhere herein, the camera 110 is a video capture device configured to capture video of at least the activity surface 102. The camera 110 may be coupled to the bus 308 for communication and interaction with the other elements of the computing device 104. The camera 110 may include a lens for gathering and focusing light, a photo sensor including pixel regions for capturing the focused light and a processor for generating image data based on signals provided by the pixel regions. The photo sensor may be any type of photo sensor including a charge-coupled device (CCD), a complementary metal-oxide-semiconductor (CMOS) sensor, a hybrid CCD/CMOS device, etc. The camera 110 may also include any conventional features such as a flash, a zoom lens, etc. The camera 110 may include a microphone (not shown) for capturing sound or may be coupled to a microphone included in another component of the computing device 104 and/or coupled directly to the bus 308. In some implementations, the processor of the camera 110 may be coupled via the bus 308 to store video and/or still image data in the memory 314 and/or provide the video and/or still image data to other elements of the computing device 104, such as the detection engine 212 and/or activity application(s) 214.

The storage 310 is an information source for storing and providing access to stored data, such as a database of virtual objects, virtual pages, virtual prompts, and/or virtual elements, gallery(ies) of virtual pages that may be displayed on the display 320, user profile information, community developed interactive sheets 116, virtual routines, virtual enhancements, etc., object data, calibration data, and/or any other information generated, stored, and/or retrieved by the activity application(s) 214.

In some implementations, the storage 310 may be included in the memory 314 or another storage device coupled to the bus 308. In some implementations, the storage 310 may be or included in a distributed data store, such as a cloud-based computing and/or data storage system. In some implementations, the storage 310 may include a database management system (DBMS). For example, the DBMS could be a structured query language (SQL) DBMS. For instance, storage 310 may store data in an object-based data store or multi-dimensional tables comprised of rows and columns, and may manipulate, i.e., insert, query, update, and/or delete, data entries stored in the verification data store 106 using programmatic operations (e.g., SQL queries and statements or a similar database manipulation library). Additional characteristics, structure, acts, and functionality of the storage 310 is discussed elsewhere herein.

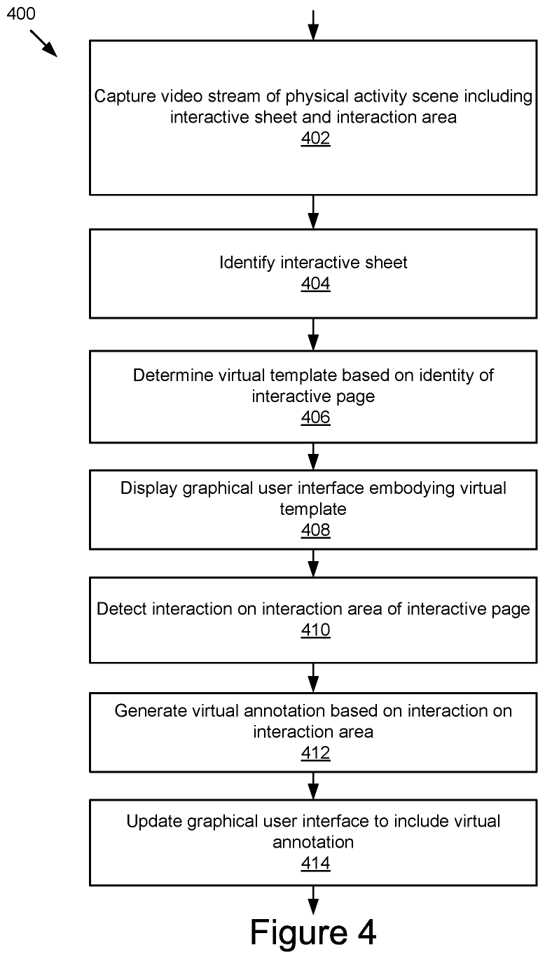

FIG. 4 is a flowchart of an example method 400 for virtualization of a physical activity scene. At 402 the video capture device 110 may capture a video stream of a physical activity scene that includes an interactive sheet 116. In some implementations, the interactive sheet 116 may include an interaction area 118 where a user can complete the interactive sheet 116 by interacting with the interaction area 118 to form markings, place objects, etc. In some implementations, the interactive sheet 116 may also include a visual marker 124 for identification of the interactive sheet 116.

At 404, the detection engine 212 may identify the interactive sheet 116. In some implementations, the detection engine 212 may identify width, height, and angle as a position of the interactive sheet 116 and relate that to a coordinate plane for the page coordinates. Additional features detected relative to the interactive sheet 116 may be mapped relative to the page coordinates. In some implementations, the detection engine 212 may identify the interactive sheet 116 using feature based identification where an image can be identified by a set of features that are unique to each worksheet. The feature based identification may include processing the image of the interactive sheet 116 to identify features and create a virtual template 112, such as a one time pre-process of the image. Then when future images of an interactive sheet 116 are captured, those features are computed fully in the image. Then the features are matched against all features from the known virtual pages and if there is a strong enough match to a virtual page, then the position information and identity of the interactive sheet 116 are computed.

Alternatively, the detection engine 212 may use feature identification where a feature on a portion of the interactive sheet 116 may be compared to identity the virtual template 112. For example, a top portion of each interactive sheet 116 may include feature-rich, contrasting details that are easily detectable by the detector 112, such as visual markings 124 as described elsewhere herein. The feature based identification may look for what is known of a generic interactive sheet 116 and find position, rotation, and/or scale of the interactive sheet 116 based on matching that feature. Matching can be done in a specific area, like a top of a page to avoid issue of user's hands/objects obscuring the features. In some implementations, machine learning may be used to further refine the matching of the feature of the page to the virtual page feature for identification.

Alternatively, the detection engine 212 may look for a visual marking 124, such as a specific code, such as a QR code or hidden code within the interactive sheet 116, such as a graphic that is visible to the user but not obvious as a code, such as alternating lines or color patterns forming a binary code, unique border edges, etc.

At 406, the activity application(s) 214 may determine a virtual template 112 based on an identity of an interactive sheet. The activity application(s) 214 may retrieve a virtual template 112 that matches the detected visual markings 124. In some implementations, at periodic intervals, the detector 304 may search for an updated visual marking 124 and if detected load in a new virtual template 112 based on the new visual markings 124. Such as when a first interactive sheet 116 is moved and a second interactive sheet 116 is placed in the field of view of the video capture device 110. At 408, the activity application(s) 214 may display a graphical user interface embodying the virtual template 112. The activity application(s) 214 may display the virtual template 112 that mirrors what is included in the interactive sheet 116. In further implementations, only relevant portions of the interactive sheet 116 may be included in the virtual template 112 or additional portions of the virtual template 112 may be presented over time. This is advantageous as it limits the amount of information presented at a single time and can help keep a user focused. In some implementations, the virtual template 112 may include a virtual prompt 120 and/or virtual elements 122 that are displayed to the user in the virtual template 112.

In some implementations, the position of the interactive sheet 116 may be aligned to the presented virtual template 112. For example, a user may place the interactive sheet 116 at an angle rather than straight on. The activity application(s) 214 may then process the angled interactive sheet 116 and correctly align the virtual template 112 for matching the interaction areas 118. The activity application(s) 214 may display the virtual template 112 in the same angled position as the interactive sheet 116 is positioned. In further implementations, the virtual template 112 may be displayed in a centered and/or straight alignment even if the interactive sheet 116 is angled or moved. By aligning the virtual template 112 to the interactive sheet 116, even if a user doesn't perfectly position the interactive sheet 116, the activity application(s) 214 has already mapped the interactive sheet 116 to the virtual template 112 and can identify corresponding areas between the two, such as the interaction areas, whether the interactive sheet 116 and the virtual template 112 appear aligned. Additionally, if the detector 304 detects a change in the position of the interactive sheet 116, such as a user moving the interactive sheet 116, the activity application(s) 214 can update the alignment to continue to correctly map portions to corresponding regions.

At 410, the detection engine 212 may detect an interaction on the interaction area 118 of the interactive sheet 116. In some implementations, the interaction may be a user responding to a virtual prompt 120 and/or completing the interactive sheet 116. In further implementations, the user may form the interaction without any virtual prompt 120. Interactions may include writing a word, letter, graphic, etc. to answer a questions, connecting lines from different answers to match them together, circling groups of objects to answer a question, coloring inside of an area, such as a coloring book, answering a match equation, translating text from one language on the interactive sheet 116 to another language in the virtual template 112, etc.

At 412, the activity application(s) 214 may generate a virtual annotation 132 based on the detected interaction on the interaction area 118. For example, responsive to the user coloring in a color in an area, the activity application(s) 214 may correspondingly fill in a portion of a virtual element 122 with a substantially similar color to the color used by the user 130. In another example, the activity application(s) 214 may display a series of steps to solve an algebra equation and compare those steps to the steps written down by a user 130 and identify and highlight any differences where the user 130 deviated from the steps. In some implementations, the activity application(s) 214 may have one or more expected markings that are expected to appear within the interaction area 118. The expected markings may be included as metadata or additional information from the virtual template 112. The activity application(s) 214 may compare the expected markings with the detected interaction that includes one or more markings and determine if the detected interaction matches any of the expected markings. In some implementations, if the detected interaction matches within a certain threshold, then the detected interaction may be identified as a match to the expected interaction.

In some implementations, the detected interaction may match below a threshold to an expected marking, but the activity application(s) 214 may determine that the detected interaction is a partial completion of the expected marking. For example, a user may be prompted to trace the letter “A” on the interactive sheet 116. The user may trace only the first side of the letter “A” and not complete the entire letter. The activity application(s) 214 may be able to identify that the first parts of the contours and shapes of the marking match with the first portion of the expected letter “A” and may signal to the user using the virtual annotation 132 that they are only partially complete and need to finish. In further implementations, the markings created by the user on the interactive page 116 may be vectorized and the vector version of the markings may be compared to the ideal and/or expected versions from the interactive sheet 116 to determine how closely they match.

In some implementations, the activity application(s) 214 may determine that the marking matches an expected marking and responsive to determining that the marking matches, the activity application may display a correct answer annotation or other graphic to signal to the user that the marking was a correct answer. In some implementations, responsive to determining that the marking did not match an expected marking for the interaction area, the activity application(s) 214 may generate an incorrect answer annotation and present the incorrect answer annotation to the user. The incorrect answer annotation may signal to the user that the answer was not matched to an expected answer. In further implementations, the incorrect answer annotation may include additional guides or hints to guide the user on how to get to the correct answer and additional virtual annotations may be displayed in the graphical user interface to assist the user in getting to the correct answer. In some implementations, the detector 304 may be able to detect when a interaction is changed, such as when a user erases or removes a first marking and places a second marking in the same interaction area. The detector 304 may be able to mask any leftover shading or extraneous markings from the first interaction so that a clean and processed second interaction showing the marking is displayed as the virtual annotation 132.

At 414, the activity application(s) 214 may display to the user in the graphical user interface, a virtual annotation responsive to the interaction that was detected on the interactive sheet 116. The virtual annotation 132 may be a virtual representation of the interaction such as a virtualization of the markings, a graphical element indicating that a choice was correct, an advancement of a character in a game displayed on the screen, a score indicating how many interactions by the user 130 were correct in the interactive sheet 116, etc. In some implementations, the character may have various voice prompts or pre-recorded statements and different statements may be played based on the detected markings on the interactive sheet 116. Such as to signal to a user if the markings are correct, or close but they need to do something else, etc.

In another implementation, the interactive sheet 116 may be an activity worksheet that has a user connect dots to create a picture or match different answers together. The activity application(s) 214 may cause the user's markings to connect the dots as a virtual annotation showing the markings on the virtual template 112 as the user creates the markings on the interactive sheet 116. In another example, the activity worksheet may be a maze that a user has to navigate through, a set of math equations, such as where the prompt is displayed on the display and the answer is selected on the interactive sheet 116. As the user forms the markings and other interactions on the interactive sheet 116, the activity application(s) generates virtual annotations 132 that correspond to the markings and other interactions in substantially real-time as they are detected.

In some implementations, a user 130 may answer questions on an interactive sheet 116 and then indicate when they are finished, such as by tapping the screen of the computing device 104, tapping a portion of the interactive sheet 116, providing an audio cue, such as “finished” or a snapping of fingers, etc. Alternatively, the computing device 104 may track the users interactions in real-time and determine when a user is complete based on details included in the virtual template 112, such as an expected amount of interactions, lack of motion for a period of time, all white space areas being filled, etc. In further implementations, the activity application(s) 214 may determine if a user needs a hint in real-time, such as an unexpected pause that prompts the activity application(s) 214 to provide a hint. In further implementations, the display screen may include a virtual character and based on how a user 130 is interacting with the interactive sheet 116, the virtual character may provide body language cues to guide the user. For example, if a student is fidgeting and not responding to a prompt, the eyes of the virtual character may subconsciously provide a cue, such as pointing to the next answer, to prompt the student to continue working on the interactive sheet 116. In further implementations, the virtual character or other elements of the virtual template 112 may provide encouragement as the student works.

In another example implementation, the interactive sheet 116 may include a series of words and the virtual prompt may ask the user 130 to “circle all words that contain short vowel sounds”. Then as the user 130 circles on the interactive sheet 116 the short vowel sounds words, the virtual template can provide indications of each circling of a word was correct or incorrect.

In some implementations, the activity application(s) 214 may switch automatically from different activities based on the identified interactive sheet 116 in front of the computing device 104. When a user 130 positions an interactive sheet 116 in front of the computing device 104, the activity application identifies the interactive sheet 116 and displays a virtual page without additional input or prompts from the user 130. If the user switches the interactive sheet 116 or turns a page of a workbook, the activity application(s) 214 will automatically display the new virtual page.

Furthermore, as the user 130 interacts with the interactive sheet 116, the virtual template 112 may include additional interactions, such as to provide additional spoken and visual instructions, provide additional facts/information about a topic, provide real-time instruction if a student is doing something incorrectly, etc. For example, if a user 130 is reading a worksheet (an example of an interactive sheet 116) and the worksheet includes the term “magnetic”, then responsive to an interaction, such as the user 130 placing a finger near the term, the virtual template 112 may display a definition of “magnetic” along with additional learning resources, such as videos or other guides. In another example, the worksheet may be a newspaper and if the user taps on an image in the newspaper of a new movie, the activity application(s) 214 may identify the text of the newspaper for context of the tap and retrieve related information, such as a movie trailer, from the internet to display to the user. In another example, a user may be using a worksheet that is written in Chinese (or another language) and response to tapping on a portion of the worksheet, the activity application(s) 214 may translate they contextual text around the tap and provide a translation or other augmented feature.

In some implementations, the interactions that may be detected include markings within the interaction area 118. For example, written markings or connections between zones (where in some instances algorithms may assume lines to be straight and rely on the continuity of the line to match the zones, or alternatively could do line tracking in real-time to match up the beginning and end. In another example, the interaction may be following a path such as a maze or letter tracing. In some implementations, following the path may include detecting multiple strokes and order enforcement, such as when tracing a character, and the enforcement may be done at the logic level and improved over time with machine learning. In further implementations, wrong lines or lines/fill outside of a boundary can be ignored and colors/white space can be matched when presenting virtualizations in the virtual template to improve the immersiveness of the platform. In some implementations, the interactions may be a selection of multiple elements, such as a circle or shape around elements or multiple selections that may intersect for further granularity. In further implementations, the interaction may be handwritten characters and the activity application(s) 214 may determine the interpretation of the handwritten characters, such as to output recognized words or numbers in a game where the user writes down answers to questions.

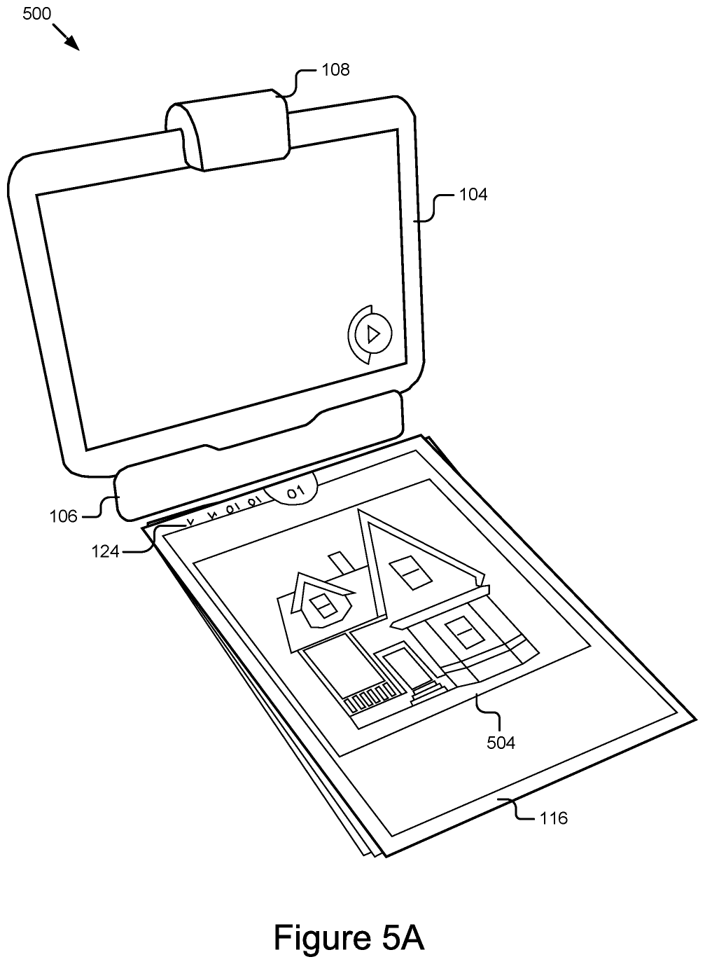

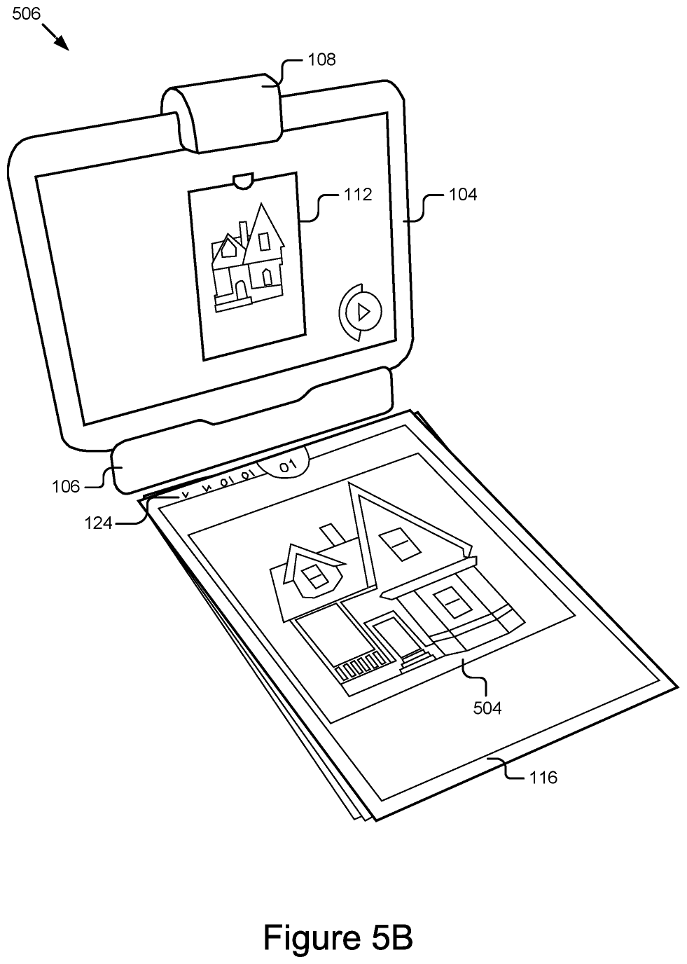

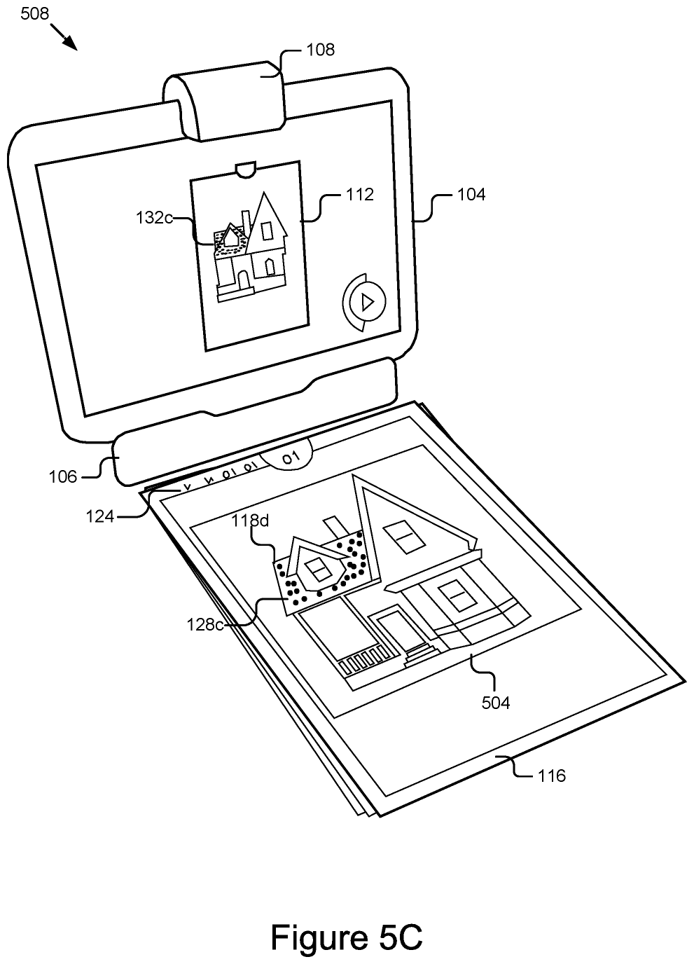

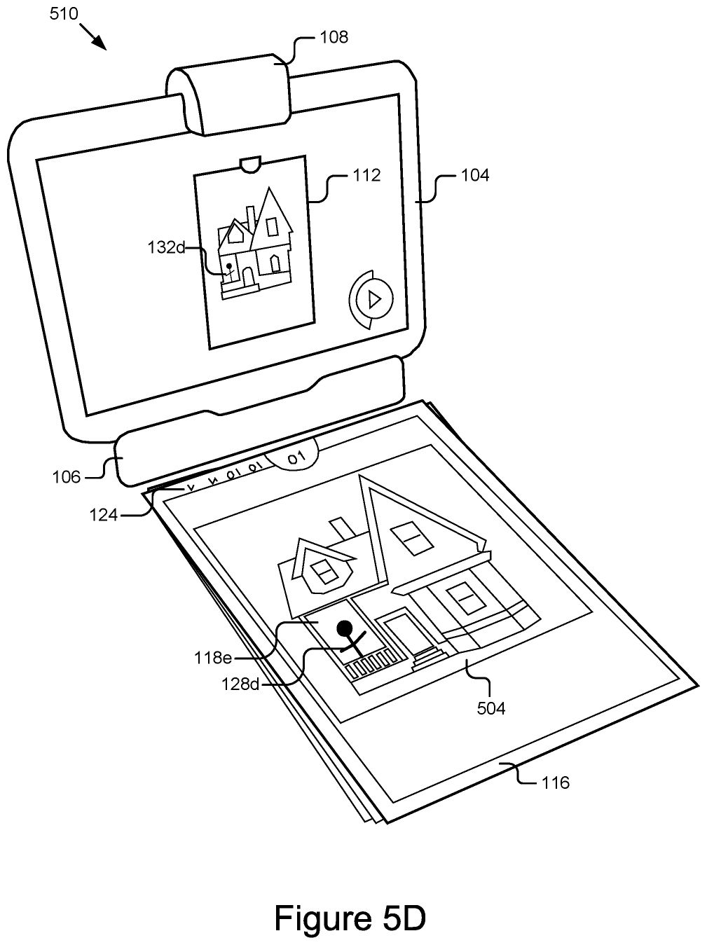

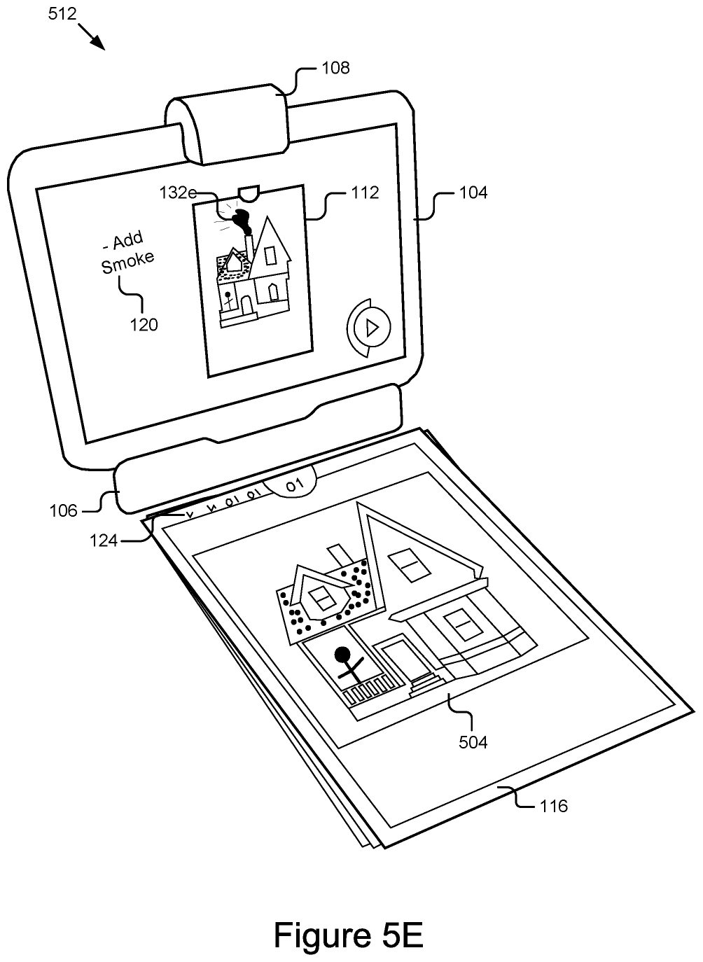

FIGS. 5A-5E are another example configuration of a physical activity visualization system. In FIG. 5A, the example configuration 500 includes a computing device 104 positioned to view an interactive sheet 116. The interactive sheet 116 may include one or more tangible objects 504, such as a picture of a house as shown in the example. The interactive sheet 116 may also include a visual marking 124 or other type of identifier that is detectable by the detector 304 in order to identify the interactive sheet 116. As shown in the example configuration 506 in FIG. 5B, when the identity of the interactive sheet 116 is identified, a virtual template 112 that is related to or associated with the interactive sheet 116 is retrieved from a storage device and displayed in a graphical user interface on the display screen. The virtual template 112 may include one or more interactable portions that may have virtual annotations 132 appear (not shown) when corresponding interactions happen on the interactive sheet 116.

For example, as shown in the example configuration 508 in FIG. 5C, an interaction area 118d may be included on the interactive sheet 116. When a user interacts with that interaction area 118d, such as by coloring 128c or adding alternative markings to that interaction area 118d, the activity application(s) 214 may process those interactions and markings 128c and display one or more corresponding virtual annotations 132c. In this example, the user is coloring or marking the roof portion of a house and as the user creates those markings on the interactive sheet 116, corresponding virtual annotations 132c appear on the aligned portions of the interactive sheet 112. In some implementations, the color and or shape of the markings may be cleaned up using image processing techniques to remove any lighting affects or distortion from the angle of the image captured in the video stream. As described elsewhere herein, the color of the virtual annotations 132 may be color corrected based on a detected color in the interaction area 118 or another portion of the interactive sheet 116 and the detected color may be used for the virtual annotations 132.

In another example configuration 510, as shown in FIG. 5D, a user may form any type of markings as an interaction 128d in an interaction area 118e. In this example, a user can draw a stick figure as the interaction 128d and the various markings of the stick figure may be captured by the video capture device 110 and recreated as a virtual annotation 132d in a corresponding area of the virtual template 112. In some implementations, the activity application(s) 214 may preserve the virtual annotations 132d even if the user removes or erases the markings in the interaction area 118e. For example, the user may erase the stick figure and draw the stick figure in a window of the house shown in the interactive sheet 116. The activity application(s) 214 may correspondingly remove the virtual annotation 132d of the stick figure or keep the stick figure based on various routines that are being executed.

In another example configuration 512, as shown in FIG. 5E, the activity application(s) 214 may display one or more virtual prompts 120 to signal to the user additional interactions that can be performed on the interactive sheet 116. In the example, the virtual prompt 120 request that the user “Add Smoke” to the object 504 depicting a house in the interactive sheet 116. The activity application(s) 214 may additionally display a virtual annotation 132e before a user has created the interaction and markings on the interactive sheet. This provides a guide and example of how the user should form their markings in the interaction areas 118. The virtual annotation 132e may be an example of an expected marking that the activity application(s) 214 use to match any interactions or markings with. By displaying these expected markings before a user creates their own markings, the activity application(s) 214 may be able to guide the user and assist them if they are stuck or confused, as described elsewhere herein.

This technology yields numerous advantages including, but not limited to, providing a low-cost alternative for developing a nearly limitless range of applications that blend both physical and digital mediums by reusing existing hardware (e.g., camera) and leveraging novel lightweight detection and recognition algorithms, having low implementation costs, being compatible with existing computing device hardware, operating in real-time to provide for a rich, real-time virtual experience, processing numerous (e.g., >15, >25, >35, etc.) tangible interface object(s) 120 and/or an interaction simultaneously without overwhelming the computing device, recognizing tangible interface object(s) 120 and/or an interaction (e.g., such as a wand 128 interacting with the physical activity scene 116) with substantially perfect recall and precision (e.g., 99% and 99.5%, respectively), being capable of adapting to lighting changes and wear and imperfections in tangible interface object(s) 120, providing a collaborative tangible experience between users in disparate locations, being intuitive to setup and use even for young users (e.g., 3+ years old), being natural and intuitive to use, and requiring few or no constraints on the types of tangible interface object(s) 120 that can be processed.

It should be understood that the above-described example activities are provided by way of illustration and not limitation and that numerous additional use cases are contemplated and encompassed by the present disclosure. In the above description, for purposes of explanation, numerous specific details are set forth in order to provide a thorough understanding of the present disclosure. However, it should be understood that the technology described herein may be practiced without these specific details. Further, various systems, devices, and structures are shown in block diagram form in order to avoid obscuring the description. For instance, various implementations are described as having particular hardware, software, and user interfaces. However, the present disclosure applies to any type of computing device that can receive data and commands, and to any peripheral devices providing services.

In some instances, various implementations may be presented herein in terms of algorithms and symbolic representations of operations on data bits within a computer memory. An algorithm is here, and generally, conceived to be a self-consistent set of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout this disclosure, discussions utilizing terms including “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Various implementations described herein may relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, including, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

The technology described herein can take the form of a hardware implementation, a software implementation, or implementations containing both hardware and software elements. For instance, the technology may be implemented in software, which includes but is not limited to firmware, resident software, microcode, etc. Furthermore, the technology can take the form of a computer program product accessible from a computer-usable or computer-readable medium providing program code for use by or in connection with a computer or any instruction execution system. For the purposes of this description, a computer-usable or computer readable medium can be any non-transitory storage apparatus that can contain, store, communicate, propagate, or transport the program for use by or in connection with the instruction execution system, apparatus, or device.

A data processing system suitable for storing and/or executing program code may include at least one processor coupled directly or indirectly to memory elements through a system bus. The memory elements can include local memory employed during actual execution of the program code, bulk storage, and cache memories that provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems, storage devices, remote printers, etc., through intervening private and/or public networks. Wireless (e.g., Wi-Fi™) transceivers, Ethernet adapters, and modems, are just a few examples of network adapters. The private and public networks may have any number of configurations and/or topologies. Data may be transmitted between these devices via the networks using a variety of different communication protocols including, for example, various Internet layer, transport layer, or application layer protocols. For example, data may be transmitted via the networks using transmission control protocol/Internet protocol (TCP/IP), user datagram protocol (UDP), transmission control protocol (TCP), hypertext transfer protocol (HTTP), secure hypertext transfer protocol (HTTPS), dynamic adaptive streaming over HTTP (DASH), real-time streaming protocol (RTSP), real-time transport protocol (RTP) and the real-time transport control protocol (RTCP), voice over Internet protocol (VOIP), file transfer protocol (FTP), Web Socket (WS), wireless access protocol (WAP), various messaging protocols (SMS, MMS, XMS, IMAP, SMTP, POP, WebDAV, etc.), or other known protocols.

Finally, the structure, algorithms, and/or interfaces presented herein are not inherently related to any particular computer or other apparatus. Various general-purpose systems may be used with programs in accordance with the teachings herein, or it may prove convenient to construct more specialized apparatus to perform the required method blocks. The required structure for a variety of these systems will appear from the description above. In addition, the specification is not described with reference to any particular programming language. It will be appreciated that a variety of programming languages may be used to implement the teachings of the specification as described herein.

The foregoing description has been presented for the purposes of illustration and description. It is not intended to be exhaustive or to limit the specification to the precise form disclosed. Many modifications and variations are possible in light of the above teaching. It is intended that the scope of the disclosure be limited not by this detailed description, but rather by the claims of this application. As will be understood by those familiar with the art, the specification may be embodied in other specific forms without departing from the spirit or essential characteristics thereof. Likewise, the particular naming and division of the modules, routines, features, attributes, methodologies and other aspects are not mandatory or significant, and the mechanisms that implement the specification or its features may have different names, divisions and/or formats.

Furthermore, the modules, routines, features, attributes, methodologies and other aspects of the disclosure can be implemented as software, hardware, firmware, or any combination of the foregoing. Also, wherever an element, an example of which is a module, of the specification is implemented as software, the element can be implemented as a standalone program, as part of a larger program, as a plurality of separate programs, as a statically or dynamically linked library, as a kernel loadable module, as a device driver, and/or in every and any other way known now or in the future. Additionally, the disclosure is in no way limited to implementation in any specific programming language, or for any specific operating system or environment. Accordingly, the disclosure is intended to be illustrative, but not limiting, of the scope of the subject matter set forth in the following claims.

What is claimed is:

1. A method comprising:
capturing, using a video capture device associated with a computing device, a video stream of a physical activity scene, the video stream including an interactive sheet, the interactive sheet including an interaction area;
identifying, using a processor of the computing device, the interactive sheet;
determining, using the processor of the computing device, a virtual template based on the identity of the interactive sheet;
displaying, on a display of the computing device, a graphical user interface embodying the virtual template;
detecting, using the processor of the computing device, an interaction on the interaction area of the interactive sheet;
generating, using the processor of the computing device, a virtual annotation based on the detected interaction on the interaction area; and
updating, on the display of the computing device, the graphical user interface to include the virtual annotation.

2. The method of claim 1, wherein the interaction further comprises a marking formed by a user in the interaction area.

3. The method of claim 2, further comprising:
detecting, using the processor of the computing device, the marking formed by the user in the interaction area; and
determining, using the processor of the computing device, whether the marking matches an expected marking for the interaction area.

4. The method of claim 3, further comprising:
responsive to the marking matching the expected marking for the interaction area, generating a correct answer annotation and presenting the correct answer annotation on the graphical user interface; and
responsive to the marking not matching the expected marking for the interaction area, generating an incorrect answer annotation and presenting the incorrect answer annotation on the graphical user interface.

5. The method of claim 4, wherein the incorrect answer annotation includes a graphical representation of steps to provide the correct answer annotation.

6. The method of claim 5, wherein the interaction on the interaction area is a marking on the interaction area and wherein the virtual annotation is a virtual representation of the marking.

7. The method of claim 1, wherein, displaying the graphical user interface embodying the virtual template further comprises:
determining, using the processor of the computing device, a position of the interactive sheet in the physical activity scene;
aligning, using the processor of the computing device, the virtual template to the interactive sheet using the position of the interactive sheet in the physical activity scene; and
displaying, using the processor of the computing device, the aligned virtual template in the graphical user interface.

8. The method of claim 7, wherein aligning the virtual template to the interactive sheet signals to the processor of the computing device where the interaction area is located on the interactive sheet based on a mapping of an expected interaction area in the virtual template.

9. The method of claim 1, wherein displaying a graphical user interface embodying the virtual template further comprises:
detecting, using the processor of the computing device, a color in the interaction area of the interactive sheet;
determining a color adjustment for the virtual template by using the detected color in the interaction area as a color of a corresponding area of the virtual template; and
displaying the virtual template in the graphical user interface with the detected color in the corresponding area of the virtual template.

10. A physical activity surface visualization system comprising:
a video capture device coupled for communication with a computing device, the video capture device being adapted to capture a video stream of a physical activity scene, the video stream including an interactive sheet, the interactive sheet including an interaction area;
a detector coupled to the computing device, the detector being adapted to identify the interactive sheet and an interaction on the interaction area of the interactive sheet;
a processor of the computing device, the processor being adapted to determine a virtual template based on the identity of the interactive sheet and generate a virtual annotation based on the detected interaction in the interaction area; and
a display coupled to the computing device, the display being adapted to display a graphical user interface embodying the virtual template and update the graphical user interface to include the virtual annotation.

11. The physical activity surface visualization system of claim 10, wherein the interaction further comprises a marking formed by a user in the interaction area.

12. The physical activity surface visualization system of claim 11 wherein the detector is further configured to detect the marking formed by the user in the interaction area wherein the processor is further configured to determine whether the marking matches an expected marking for the interaction area.

13. The physical activity surface visualization system of claim 12, further comprising:
responsive to the marking matching the expected marking for the interaction area, the processor is further configured to generate a correct answer annotation and presenting the correct answer annotation on the graphical user interface; and
responsive to the marking not matching the expected marking for the interaction area, the processor is further configured to generate an incorrect answer annotation and presenting the incorrect answer annotation on the graphical user interface.

14. The physical activity surface visualization system of claim 13, wherein the incorrect answer annotation includes a graphical representation of steps to provide the correct answer annotation.

15. The physical activity surface visualization system of claim 14, wherein the interaction on the interaction area is a marking on the interaction area and wherein the virtual annotation is a virtual representation of the marking.

16. The physical activity surface visualization system of claim 10, wherein:
the processor is further configured to determine a position of the interactive sheet in the physical activity scene and align the virtual template to the interactive sheet using the position of the interactive sheet in the physical activity scene; and
the display is further configured to present the aligned virtual template in the graphical user interface.

17. The physical activity surface visualization system of claim 16, wherein when the processor aligns the virtual template to the interactive sheet the processor identifies where the interaction area is located on the interactive sheet based on a mapping of an expected interaction area in the virtual template.

18. The physical activity surface visualization system of claim 10, wherein:
the processor is further configured to detect a color in the interaction area of the interactive sheet and determine a color adjustment for the virtual template by using the detected color in the interaction area as a color of a corresponding area of the virtual template; and
the display is further configured to display the virtual template in the graphical user interface with the detected color in the corresponding area of the virtual template.

19. A method comprising:
capturing, using a video capture device associated with a computing device, a video stream of a physical activity scene, the video stream including an interactive sheet that includes one or more interaction areas and a visual marking;
detecting, using a processor of the computing device, the visual marking from the video stream;
identifying, using the processor of the computing device, the detected visual marking;
retrieving, using the processor of the computing device, a virtual template based on the identified visual marking;
aligning, using the processor of the computing device, the virtual template with a position of the interactive sheet;
determining, using the processor of the computing device, an expected location of the one or more interaction areas from the virtual template based on the aligning of the virtual template;
detecting, using the processor of the computing device, an interaction in the one or more interaction areas on the interactive sheet using the expected location of the one or more interaction areas;
identifying, using the processor of the computing device, the interaction in the one or more interaction areas;
generating, using the processor of the computing device, a virtual annotation based on the identity of the interaction; and
displaying, on a display of the computing device, a graphical user interface that includes the virtual template and the virtual annotation.

20. The method of claim 19, wherein the interaction is a marking formed by a user in the one or more interaction areas.
